(19) United States
(12) Patent Application Publication
(10) Pub. No.: US 2017/0256096 A1
(43) Pub. Date: Sep. 7, 2017

(54) INTELLIGENT OBJECT SIZING AND PLACEMENT IN A AUGMENTED / VIRTUAL REALITY ENVIRONMENT

(71) Applicant: GOOGLE INC., Mountain View, CA (US)

(72) Inventors: Alexander James FAABORG, Mountain View, CA (US); Manuel Christian CLEMENT, Felton, CA (US)

(21) Appl. No.: 15/386,854

(22) Filed: Dec. 21, 2016

Related U.S. Application Data
(60) Provisional application No. 62/304,700, filed on Mar. 7, 2016.

(51) Int. Cl. G06T 19/00; G06K 9/62; G06T 19/20

(52) U.S. Cl. CPC G06T 19/006; G06T 19/003; G06T 19/20; G06K 9/6202; G06T 2219/2004; G06T 2219/2016; G06F 3/0481

(57) ABSTRACT

In a system for intelligent placement and sizing of virtual objects in a three dimensional virtual model of an ambient environment, the system may collect image information and feature information of the ambient environment, and may process the collected information to render the three dimensional virtual model. From the collected information, the system may define a plurality of drop target areas in the virtual model, each of the drop target areas having associated dimensional, textural, and orientation parameters. When placing a virtual object in the virtual model, or placing a virtual window for launching an application in the virtual model, the system may select a placement for the virtual object or virtual window, and set a sizing for the virtual object or virtual window, based on the parameters associated with the plurality of drop targets.

### CROSS REFERENCE TO RELATED APPLICATION(S)

This application claims priority to U.S. Provisional Application No. 62/304,700, filed on Mar. 7, 2016, the disclosures of which are incorporated by reference herein

### FIELD

This application relates, generally, to object sizing and placement in a virtual reality and/or augmented reality environment.

### BACKGROUND

An augmented reality (AR) system and/or a virtual reality (VR) system may generate a three-dimensional (3D) immersive augmented/virtual reality environment. A user may experience this virtual environment through interaction with various electronic devices. For example, a helmet or other head mounted device including a display, glasses or goggles that a user looks through, either when viewing a display device or when viewing the ambient environment, may provide audio and visual elements of the virtual environment to be experienced by a user. A user may move through and interact with virtual elements in the virtual environment through, for example, hand/arm gestures, manipulation of external devices operably coupled to the head mounted device, such as for example a handheld controller, gloves fitted with sensors, and other such electronic devices.

### SUMMARY

In one aspect, a method may include capturing, with one or more optical sensors of a computing device, feature information of an ambient environment; generating, by a processor of the computing device, a three dimensional virtual model of the ambient environment based on the captured feature information; processing, by the processor, the captured feature information and the three dimensional virtual model to define a plurality of virtual drop targets in the three dimensional virtual model, the plurality of virtual drop targets being respectively associated with a plurality of drop regions; the computing device, a request to place a virtual object in the three dimensional virtual model; selecting, by the computing device, a virtual drop target, of the plurality of virtual drop targets, for placement of the virtual object in the three dimensional virtual model, based on attributes of the virtual object and characteristics of the plurality of virtual drop targets; sizing, by the computing device, the virtual object based on the characteristics of the selected virtual drop target; and displaying the sized virtual object at the selected drop virtual target in the displayed three dimensional virtual model.

In another aspect, computer program product embodied on a non-transitory computer readable medium, the computer readable medium having stored thereon a sequence of instructions. When executed by a processor, the instructions may cause the processor to execute a method, the method including capturing, with one or more optical sensors of a computing device, feature information of an ambient environment; generating, by a processor of the computing device, a three dimensional virtual model of the ambient environment based on the captured feature information; processing, by the processor, the captured feature information and the three dimensional virtual model to define a plurality of virtual drop targets in the three dimensional virtual model, the plurality of virtual drop targets being respectively associated with a plurality of drop regions; the computing device, a request to place a virtual object in the three dimensional virtual model; selecting, by the computing device, a virtual drop target, of the plurality of virtual drop targets, for placement of the virtual object in the three dimensional virtual model, based on attributes of the virtual object and characteristics of the plurality of virtual drop targets; sizing, by the computing device, the virtual object based on the characteristics of the selected virtual drop target; and displaying the sized virtual object at the selected drop virtual target in the displayed three dimensional virtual model.

In another aspect, a computing device may include a memory storing executable instructions, and a processor configured to execute the instructions. The instructions may cause the computing device to capture feature information of an ambient environment; generate a three dimensional virtual model of the ambient environment based on the captured feature information; process the captured feature information and the three dimensional virtual model to define a plurality of virtual drop targets associated with a plurality of drop regions identified in the three dimensional virtual model; receive a request to include a virtual object in the three dimensional virtual model; select a virtual drop target, of the plurality of virtual drop targets, for placement of the virtual object in the three dimensional virtual model, and automatically size the virtual object for placement at the selected virtual drop target based on characteristics of the selected virtual drop target and previously stored criteria and functional attributes associated with the virtual object; and display the sized virtual object at the selected virtual drop target in the displayed three dimensional virtual model.

The details of one or more implementations are set forth in the accompanying drawings and the description below. Other features will be apparent from the description and drawings, and from the claims.

### BRIEF DESCRIPTION OF THE DRAWINGS

FIGS. 1A-1G illustrate an example implementation of intelligent object sizing and placement in an augmented reality system and/or a virtual reality system, in accordance with implementations as described herein.

FIG. 2 illustrates an example virtual workstation generated by an augmented reality system and/or a virtual reality system, in accordance with implementations as described herein.

FIGS. 3A-3E illustrate example implementations of intelligent object sizing and placement in an augmented reality system and/or a virtual reality system, in accordance with implementations as described herein.

FIG. 4 is an example implementation of an augmented reality/virtual reality system including a head mounted display device and a controller, in accordance with implementations as described herein.

FIGS. 5A-5B are perspective views of an example head mounted display device, in accordance with implementations as described herein.

FIG. 6 is a block diagram of a head mounted electronic device and a controller, in accordance with implementations as described herein.

FIG. 7 is a flowchart of a method of intelligent object sizing and placement in an augmented reality system and/or a virtual reality system, in accordance with implementations as described herein.

FIG. 8 shows an example of a computer device and a mobile computer device that can be used to implement the techniques described herein.

### DETAILED DESCRIPTION

A user may experience an augmented reality environment or a virtual reality environment generated by for example, a head mounted display (HMD) device. For example, in some implementations, an HMD may block out the ambient environment, so that the virtual environment generated by the HMD is completely immersive, with the user's field of view confined to the virtual environment generated by the HMD and displayed to the user on a display contained within the HMD. In some implementations, this type of HMD may capture three dimensional (3D) image information related to the ambient environment, and real world features of and objects in the ambient environment, and display rendered images of the ambient environment on the display, sometimes together with virtual images or objects, so that the user may maintain some level of situational awareness while in the virtual environment. In some implementations, this type of HMD may allow for pass through images captured by an imaging device of the HMD to be displayed on the display of the HMD to maintain situational awareness. In some implementations, at least some portion of the HMD may be transparent or translucent, with virtual images or objects displayed on other portions of the HMD, so that portions of the ambient environment are at least partially visible through the HMD. A user may interact with different applications and/or virtual objects in the virtual environment generated by the HMD through, for example, hand/arm gestures detected by the HMD, movement and/or manipulation of the HMD itself, manipulation of an external electronic device, and the like.

A system and method, in accordance with implementations described herein, may generate a 3D model of the ambient environment, or real world space, and display this 3D model to the user, via the HMD, together with virtual elements, objects, applications and the like. This may allow the user to move in the ambient environment while immersed in the augmented/virtual reality environment, and to maintain situational awareness while immersed in the augmented/virtual reality environment generated by the HMD. A system and method, in accordance with implementations described herein, may use information from the generation of this type of 3D model of the ambient environment to facilitate intelligent sizing and/or placement of augmented reality/virtual reality objects generated by the HMD. These objects may include, for example, two dimensional windows running applications, which may be sized and positioned in the augmented/virtual reality environment to facilitate user interaction.

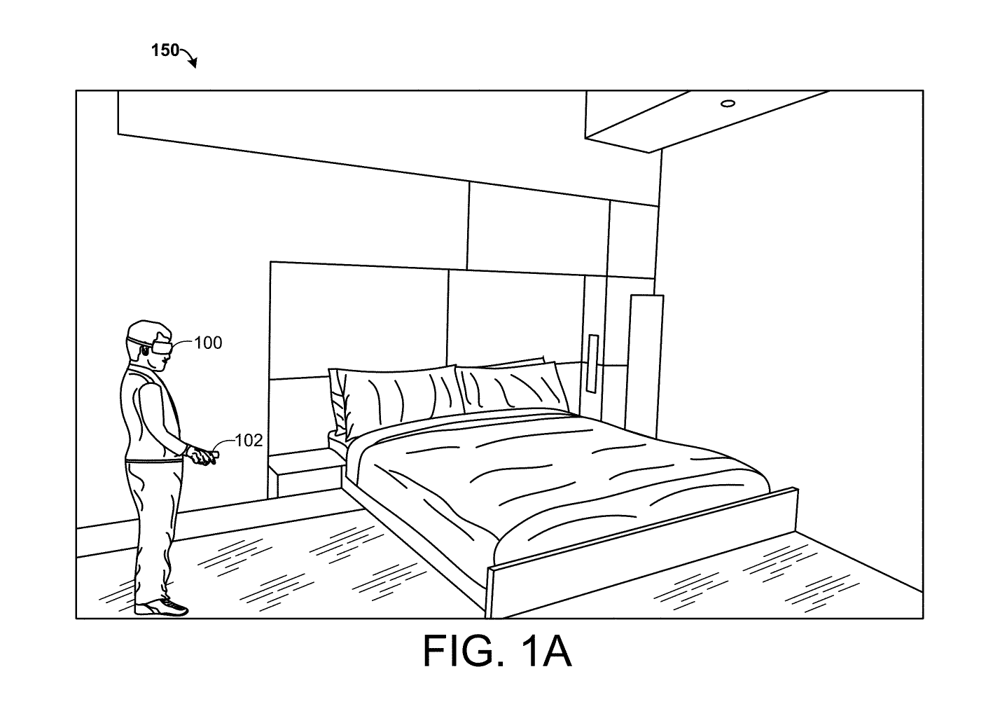

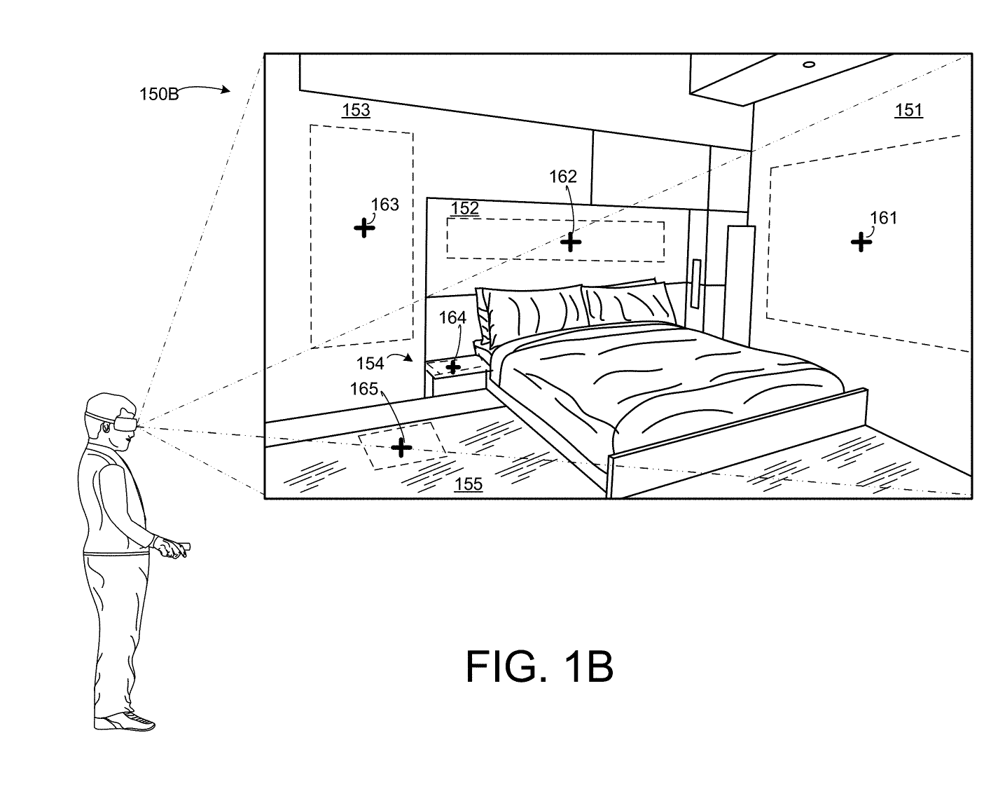

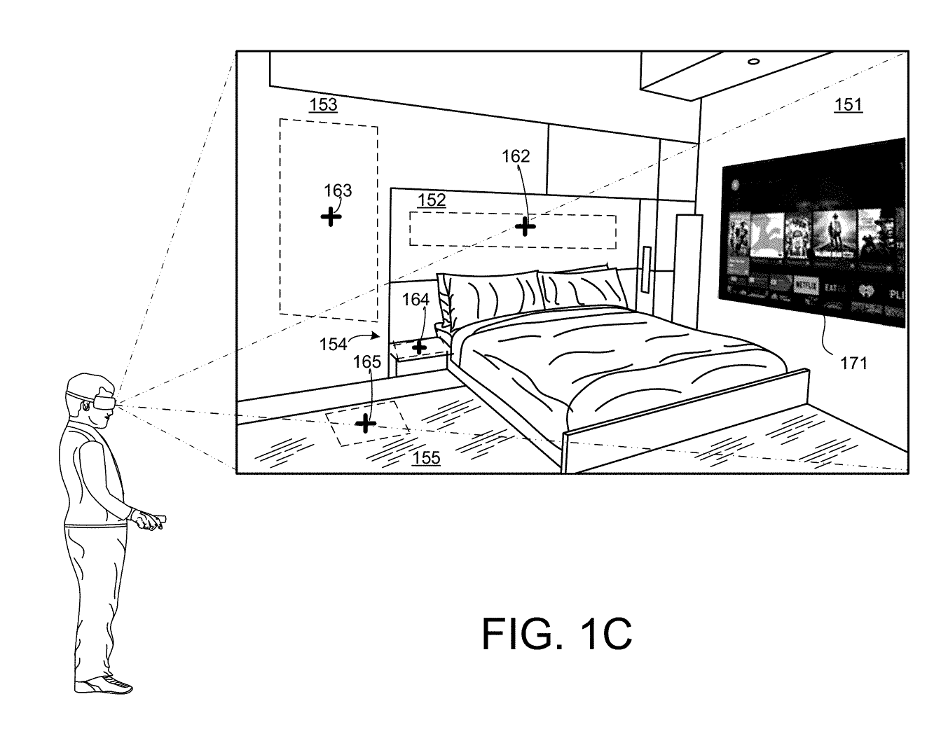

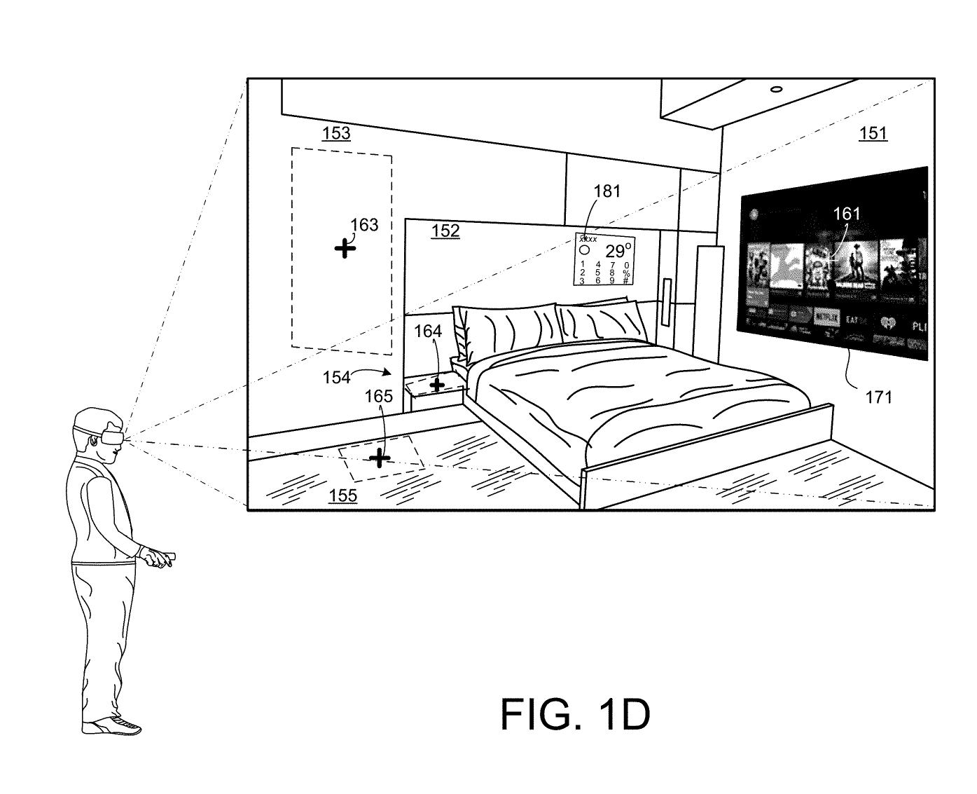

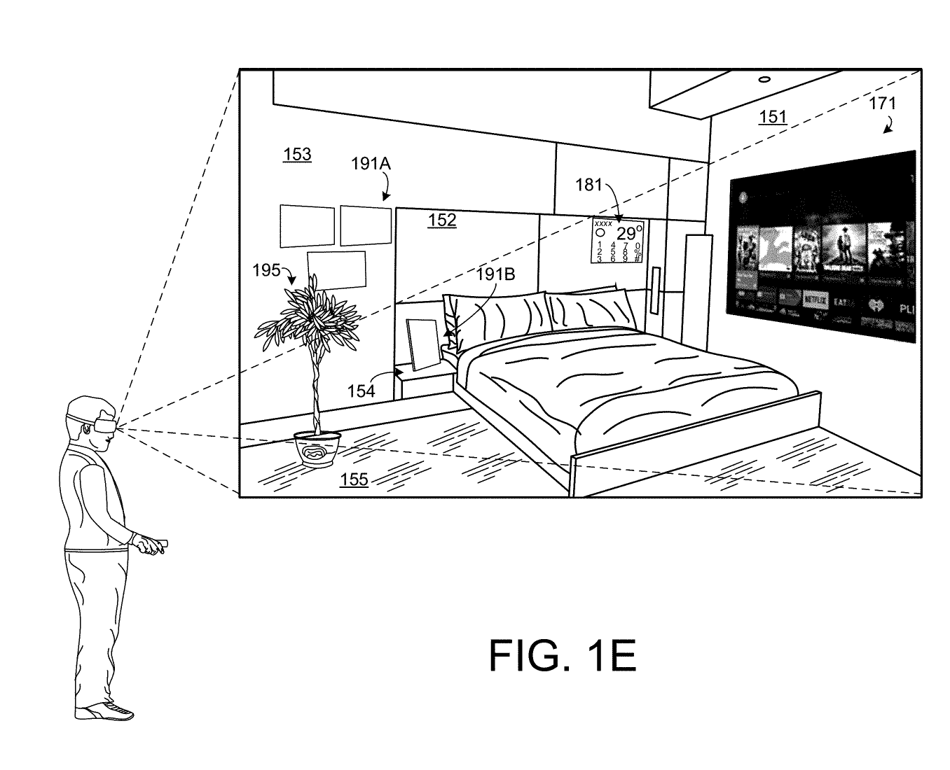

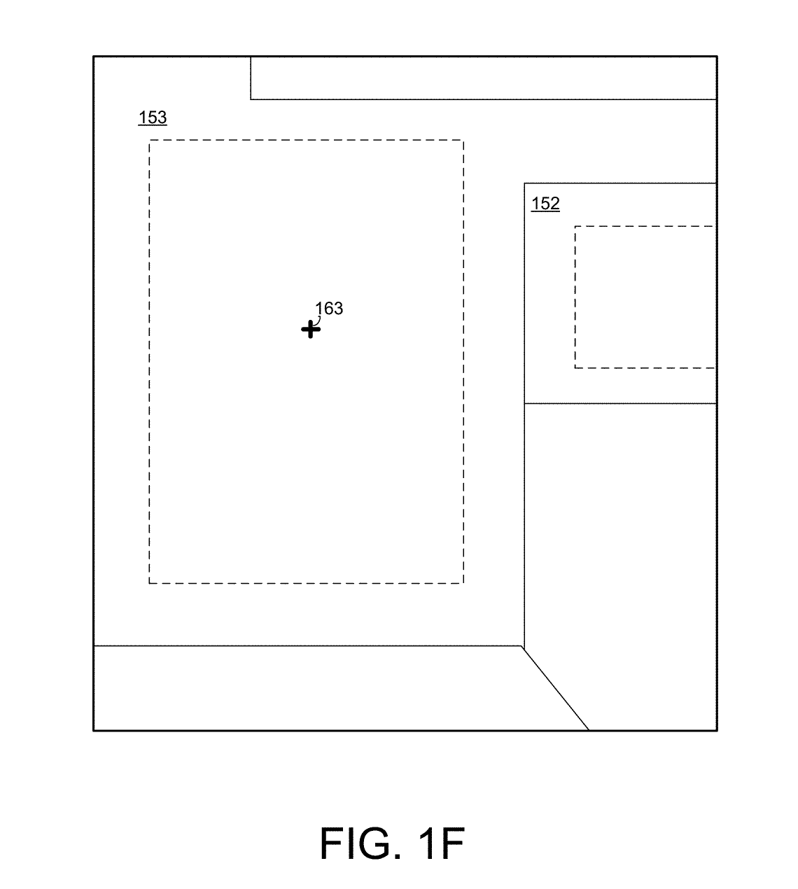

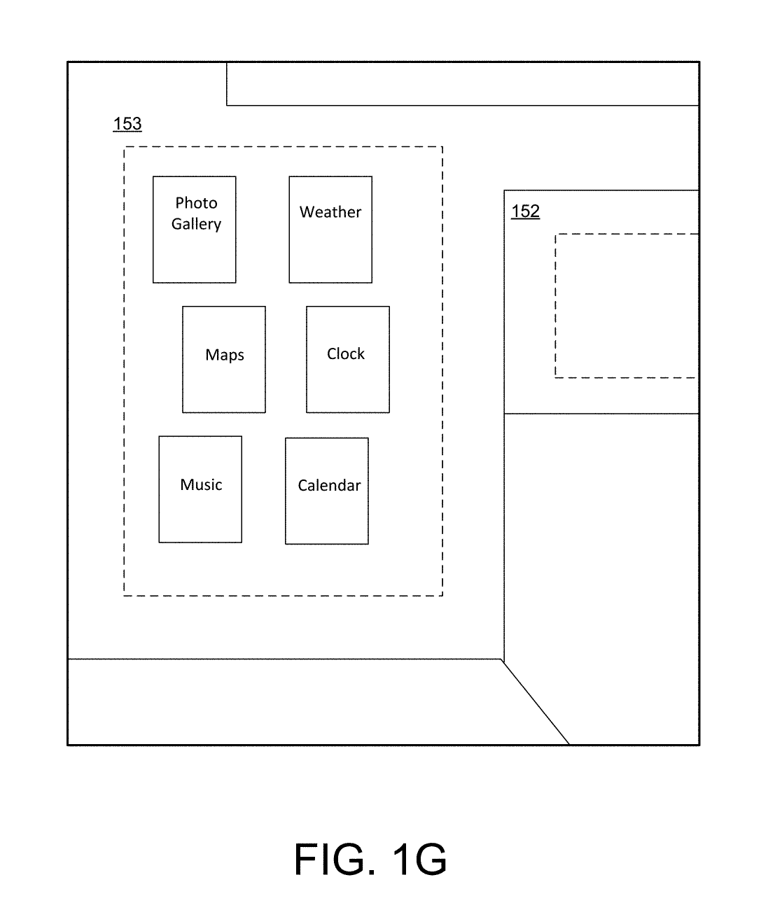

The example implementation shown in FIGS. 1A-1E will be described with respect to a user wearing an HMD that substantially blocks out the ambient environment, so that the HMD generates a virtual environment, with the user's field of view confined to the virtual environment generated by the HMD. However, the concepts and features described below with respect to FIGS. 1A-1E may also be applied to other types of HMDs, and other types of virtual reality environments and augmented reality environments as described above. The example implementation shown in FIG. 1A is a third person view of a user wearing an HMD 100, facing into a room defining the user's current ambient environment 150, or current real world space. The HMD 100 may capture images and/or collect information defining real world features in the ambient environment 150. The images and information collected by the HMD 100 may then be processed by the HMD 100 to render and display a 3D model 150B of the ambient environment 150. The 3D rendered model 150B may be displayed to and viewed by the user, for example, on a display of the HMD 100. In FIG. 1B, the 3D rendered model 150B is illustrated outside of the confines of the HMD 100, simply for ease of discussion and illustration. In some implementations, this 3D rendered model 150B of the ambient environment 150 may be representative of the actual ambient environment 150, but not necessarily an exact reproduction of the ambient environment 150 (as it would be if, for example, a pass through image from a pass through camera were displayed instead of a rendered 3D model image). The HMD 100 may process captured images of the ambient environment 150 to define and/or identify various real world features in the ambient environment 150, such as, for example, corners, edges, contours, flat regions, textures, and the like. From these identified real world features, other characteristics of the ambient environment 150, such as, for example, a relative area associated with identified flat regions, an orientation of identified flat regions (for example, horizontal, vertical, angled) a relative slope associated with contoured areas, and the like may be determined.

In some implementations, one or more previously generated 3D models of one or more known ambient environments may be stored. An ambient environment may be recognized by the system as corresponding to one of the known ambient environments/stored 3D models, at a subsequent time, and the stored 3D model of the ambient environment may be accessed for use by the user. In some implementations, the previously stored 3D model of the known ambient environment may be accessed as described, and compared to a current scan of the ambient environment, so that the 3D model may be updated to reflect any changes in the known ambient environment such as, for example, changes in furniture placement, other obstacles in the environment and the like which may obstruct the user's movement in the ambient environment and detract from the user's ability to maintain presence. The updated 3D model may then be stored for access during a later session.

As noted above, a third person view of the 3D model 150B of the ambient environment 150, as would be viewed by the user on the display of the HMD 100, is shown on the right portion of FIG. 1B. With the 3D model 150B of the ambient environment 150 rendered and displayed to the user, the user may choose to, for example, launch an application. For example, the user may choose to launch a video streaming application by, for example, manipulation of a handheld device 102, manipulation of the HMD 100, a voice command detected and processed by the HMD 100 or by the handheld device 102 (and transmitted to the HMD 100), a head gesture detected by the HMD 100, a hand gesture detected by the HMD 100 or the handheld device 102, and the like. In response to detecting the user's command to launch the example video streaming application, the system may determine a sizing and a placement of a window in which the video streaming application may be displayed. This may be determined based on, for example, the images captured and information collected in generating the 3D model 150B of the ambient environment 150.

For example, in determining a region or area for display of a window in which to launch the requested video streaming application, the system may examine various drop targets created as the real world feature is collected from the ambient environment 150 and the 3D model 150B of the ambient environment 150 is rendered. For example, as shown in FIG. 1B, a first drop target 161 may be identified on a first flat region 151, a second drop target 162 may be identified on a second flat region 152, a third drop target 163 may be identified on a third flat region 153, a fourth drop target 164 may be identified on a fourth flat region 154, a fifth drop target 165 may be identified on a fifth flat region 155, and the like. Numerous other drop target areas may be identified throughout the 3D model 150B of the ambient environment 150, based on the real world features, geometry, contours and the like detected and identified as the images of the ambient environment 150 are captured, and there may be more, or fewer, drop target areas identified in the 3D model 150B of the ambient environment 150. Characteristics of the various drop target areas 161, 162, 163, 164 and 165, such as, for example, size, area, orientation, surface texture and the like, may be associated with each of the drop target areas 161, 162, 163, 164 and 165. These characteristics may be taken into consideration for automatically selecting a drop target for a particular application or other requested virtual object, and in sizing the requested application or virtual object for incorporation into the virtual environment.

In response to detecting the user's command to launch the video streaming application in the example above, the system may select, for example, the first drop target 161 on the first flat region 151 for display of a video streaming window 171, as shown in FIG. 1C. Selection of the first drop target 161 for placement of the video streaming window 171 may be made based on, for example, a planarity, or flatness, of the first drop target 161, a size of the first drop target 161 and/or and area of the first drop target 161 and/or a shape of the first drop target 161 and/or aspect ratio (i.e., a ratio of length to width) of the area of the first drop target 161, a texture of the first drop target 161, and other such characteristics which may be already known based on the images and information collected for rendering of the 3D model 150B. These characteristics of the first drop target 161 may be measured, or considered, or compared to known requirements and/or preferences associated with the requested video streaming application, such as, for example, a relatively large, relatively flat display area, a display area positioned opposite a horizontal seating area, and the like. Rules and algorithms for selection of a drop target for placement of a particular application and/or virtual object may be set in advance, and/or may be adjusted based on user preferences.

In selection of a drop target area, for example, for display of the video streaming window 171 in the example discussed above, relatively high priority may be given to drop target areas having, for example, larger size and/or display area and/or a desired aspect ratio, and having a relatively smooth texture, to provide the best video image possible. In the example shown in FIGS. 1B and 1C, an area and an aspect ratio of the first drop target 161 are known, and so the video streaming window 171 may be automatically sized to make substantially full use of the available area associated with the first drop target 161.

The user may choose to, for example, launch another, different application, having different display characteristics and requirements than those associated with the video streaming application. For example, the user may choose to launch an informational type application, such as, for example, a local weather application, by, for example, manipulation of the handheld device 102, manipulation of the HMD 100, a voice command detected by the HMD 100 and/or the handheld device 102, a hand gesture detected by the HMD 100 or the handheld device 102, and the like. Rules, preferences, algorithms and the like associated with the local weather application for selection of a drop target may differ from the rules, preferences algorithms and the like associated with selection of a drop target for display of the video streaming application. For example, a size and/or area to be occupied by an informational window 181 may be relatively smaller than that of the video streaming window 171, as the information displayed in the informational window 181 may be only intermittently viewed/referred to by the user, and the information provided may occupy a relatively small amount of visual space. Similarly, while a relatively smooth texture or surface may be desired for placement of the video streaming window 171, image quality of the static information displayed in the informational window 181 may not be affected as much by surface texture. Further, while preferences for location for the video streaming window 171 may be associated with, for example, comfortable viewing heights, arrangements across from seating areas and the like, a particular location for the placement of the informational window 181 may be less critical.

In response to detecting the user's command to launch the weather application, the system may determine a sizing and a placement of the informational window 181 in which the weather application may be displayed, as described above. In the example shown in FIG. 1D, based on the established rules, preferences, algorithms and the like, the informational window 181 may be automatically positioned in the area of the second drop target 162, and automatically sized to fit in the area of the second drop target 162.

In some situations, the user may wish to personalize a particular space with, for example, one or more familiar, personal items such as, for example, family photos and the like. Virtual 3D models of these personal items may be, for example, previously stored for access by the HMD 100. For example, as shown in FIG. 1E, in response to a detected user request for personalization, one or more virtual wall photo(s) 191A may be positioned in an area of the third drop target 163, and one or more virtual tabletop photo(s) 191B may be positioned in an area of the fourth drop target 164. In positioning the virtual wall photo(s) 191A, the system may select the third drop target 163 based not just on size/area/aspect ratio, but also based on, for example, a vertical orientation of the third flat region 153 associated with the third drop target 163 capable of accommodating the selected virtual wall photo(s) 191A, and automatically size the virtual wall photo(s) 191A to the available area as described above. Similarly, in positioning the virtual tabletop photo(s) 191B, the system may select the third drop target 163 based not just on size/area/aspect ratio, but also based on, for example, a horizontal orientation of the fourth flat region 154 associated with the fourth drop target 164 capable of accommodating the selected virtual tabletop photo(s) 191B, and automatically size the virtual tabletop photo(s) 191B to the available area as described above.

Similarly, as shown in FIG. 1E, in response to a detected user request for personalization, virtual object such as, for example, a plant 195 may be positioned in an area of the fifth drop target 165. In positioning the plant 195, the system may select the fifth drop target 165 based not just on size/area/aspect ratio, but also based on, for example, detection that the fifth drop target 165 is defined on the fifth flat region 155 corresponding to a virtual horizontal floor area of the 3D model 150B of the ambient environment 150. Positioning of the plant 195 at the fifth drop target 165 may allow for the virtual plant 165 to be positioned on the vertical floor and extend upward into the virtual space.

In some implementations, the user may walk in the ambient environment 150, and move accordingly in the virtual environment 150B, and may approach one of the defined drop targets 161-165. In the example shown in FIG. 1F, the user has walked towards and is facing the third flat region 153, corresponding to the third drop target 163. As the user's movement in the ambient environment 150, and corresponding movement with respect to the 3D model and any virtual features in the virtual environment, may be tracked by the system, the system may detect the user in proximity of the third flat region 153/third drop target 163, and/or facing the third flat region 153/third drop target 163. In some implementations, in response to the detection of the user in proximity of/facing the third flat region 153/third drop target 153, the system may display, for example, an array of applications for available to the user. The applications presented to the user for selection on the third flat region 153/in the area of the third drop target 163 may be intelligently selected for presentation to the user based on the known characteristics of the third flat region 153/third drop target 163, as described above.

That is, the system may detect the user's position and orientation in the ambient environment 150 (and corresponding position and orientation in the virtual environment 150B) and determine that the user is in proximity of/facing the third flat region 153/third drop target 163. Based on the characteristics of the third drop target 163 as described above (for example, a planarity, a size and/or and area and/or shape and/or aspect ratio, a texture, and other such characteristics of the third drop target 163), the system may select an array of applications and other virtual features, objects, elements and the like, which may be well suited for the third drop target 163, as shown in FIG. 1G.

The applications, elements, features and the like displayed to the user for execution at the third drop target 163 may be selected not only based on the known characteristics of the third drop target 163, but also known characteristics of the applications. For example, photos, maps and the like may be displayed well at the third drop target 163 given, for example, the known size, surface texture, planarity, and vertical orientation of the third flat region 153/third drop target 163. However, virtual renderings of personal items requiring a horizontal orientation (such as, for example, the plant 195 shown in FIG. 1E) are not automatically presented for selection by the user, as the third flat region 153/third drop target 163 does not include a horizontally oriented area to accommodate this type of personal item. Similarly, the characteristics of the third drop target 163 (size, planarity and the like) may accommodate a video streaming application. However, a video streaming application may be less suitable for execution at the third drop target 163, as, based on the known characteristics of the ambient environment 150 (based on the information captured 150B in the generation of the 3D model), there is no seating positioned in the ambient environment 150 to provide for comfortable viewing of a video streaming application running on the third flat region 153/third drop target 163. This intelligent selection of applications, elements, features and the like, automatically presented to the user as the user approaches a particular flat region/drop target, may further enhance the user's experience in the augmented/virtual reality environment. In some implementations, the user may be present in a first ambient environment, with a plurality of virtual objects displayed in the 3D virtual model of the first ambient environment, as described above. For example, the user may be present in a first, real world, room, immersed in the virtual environment, with an application window displayed in a 3D virtual model of the first room displayed to the user. The user may then choose to move to a second ambient environment or second, real world, room. In generating and displaying a 3D virtual model of the second room, the system may re-size and re-place the application window in the 3D virtual model of the second room, based on, for example, available flat regions in the second room and characteristics associated with the available flat regions in the second room as described above, as well as requirements associated with the application running in the virtual application window, without further intervention or interaction by the user.

In some implementations, the augmented reality/virtual reality system may collect and store images and information related to different ambient environments, or real world spaces, and related 3D model rendering information. When encountering a particular ambient environment, the system may identify various real world features of the ambient environment, such as, for example, corners, flat regions and orientations and textures of the flat regions, contours and the like, and may recognize the ambient environment based on the identified features. This recognition of features may facilitate the subsequent rendering of the 3D model of the ambient environment, and facilitate the automatic, intelligent sizing and placement of virtual objects. The system may also recognize changes in the ambient environment in a subsequent encounter, such as, for example, change(s) in furniture placement and the like, and update the 3D model of the ambient environment accordingly.

In some implementations, the system may identify and recognize certain features in an ambient environment that are particularly suited for a specific application. For example, in some implementations, the system may detect a flat region, that is oriented horizontally, with an area greater than or equal to a previously set area, and that is positioned within a set vertical range within the ambient environment. The system may determine, based on the detected characteristics of the flat region, that the detected flat region may be appropriate for a work surface such as, for example, a virtual work station.

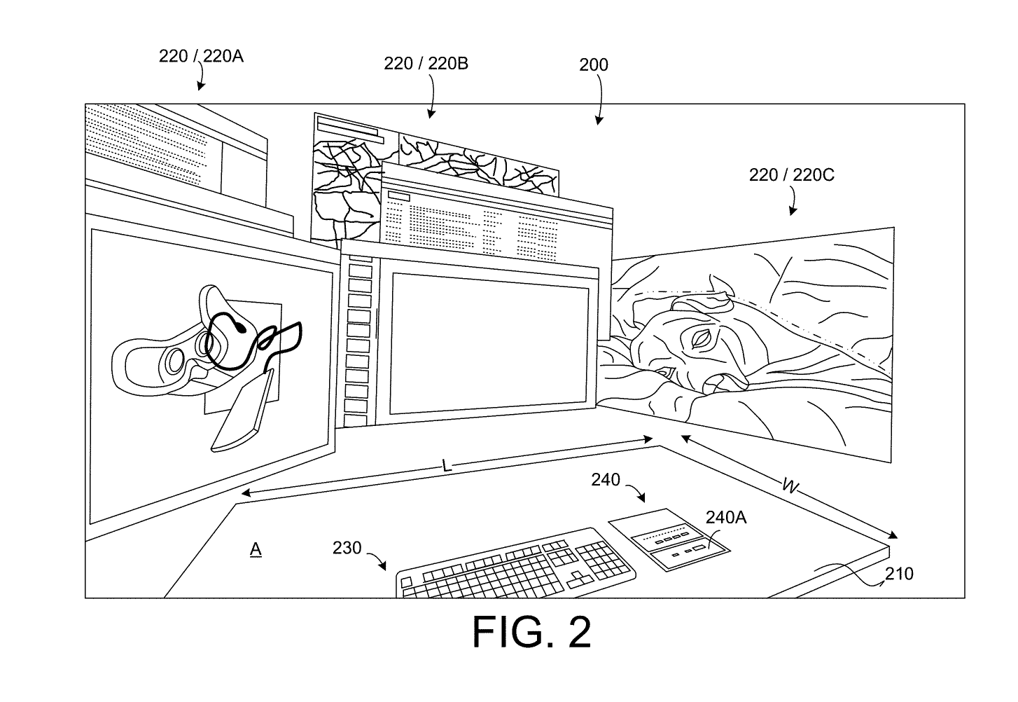

For example, as shown in FIG. 2, from the images and information collected in rendering the 3D model of the ambient environment, the system may detect a flat region 210 having an area A, with a length L and a width W. The system may also detect a vertical position of the flat region 210 relative to a set user reference point, such as, for example, relative to the floor, relative to a waist level of the user, relative to a head level of the user, within an arms reach of the user, and other such exemplary reference points. Based on the available area A, as well as the length L of the flat region 210 and the vertical position of the flat region 210 relative to the user, the system may determine that the flat region 210 may accommodate a virtual workstation 200. The determination that the detected flat region 210 may accommodate a virtual workstation 200 may include, for example, a determination of a number and an arrangement of virtual display screens 220 which may be accommodated based on, for example, the length L of the flat region 210. Similarly, the determination that the detected flat region 210 may accommodate a virtual workstation 200 may include, for example, a determination that the virtual workstation 200 may accommodate a virtual keyboard 230 based on, for example, the vertical position of the flat region 210 relative to a set user reference point indicating that the flat region 210 is at a suitable height to facilitate user interaction and typing. The set user reference point may be, for example, a point at the user's head, for example, on the HMD, with the flat region 210 being positioned at a vertical distance from the set user reference point to facilitate typing, for example, within a range corresponding to an arm's length.

Based on the detected sizing and positioning of the flat region 210, the HMD 100, functioning as a computing device, may display the virtual workstation 200 including, for example, an array of frequently used virtual display screens 220A, 220B and 220C. Based on the length L of the flat region 210, and in some implementations based on the length L and the width W of the flat region 201, the array of virtual display screens 220 may be arranged as an array of three sets of virtual display screens 220A, 220B and 220C, partially surrounding the user, with each including vertically stacked layers of virtual screens, as shown in FIG. 2. The position of the plurality of virtual display screens 220 in the horizontal arrangement, and/or the order of the vertical layering of the plurality of virtual display screens 220 may be based on, for example, historical usage that is collected, stored and updated by the system, and/or may be set by the user based on user preferences. Similarly, once displayed, the position and order of the virtual display screens 220 screens may be re-arranged by the user by, for example, hand gesture(s) grasping and moving the virtual display screen(s) 220 into new virtual position(s), manipulation of a handheld controller and/or the HMD, head and/or eye gazed based selection and movement, and other various manipulation, input and interaction methods described above.

In some implementations, the HMD 100, functioning as a computing device, may also display a virtual keyboard 230 on the flat region 210. The user may manipulate and provide inputs at the virtual keyboard 230 to interact with one or more of the virtual display screens 220 displayed in the array. The positioning of the virtual keyboard 230 at a position corresponding to the real world physical work surface in the ambient environment (corresponding to the flat region 210) may provide for a certain level of physical feedback as the user's fingers move into virtual contact with the virtual keys of the virtual keyboard 230, and then into physical contact with the physical work surface defining the flat region 210. This physical feedback may simulate a physical response experienced when typing on a real world physical keyboard, thus improving the user's experience and improving accuracy of entries/inputs made by the user via the virtual keyboard 230. In some implementations, the user's hands, and movement of the user's hands, may be tracked so as to determine intended keystrokes as the user's fingers make virtual contact with the virtual keys of the virtual keyboard 230, and the like, associated with the inputs made by the user via the virtual keyboard 230, and to implement inputs entered by the user via the virtual keyboard 230. in some implementations, a pass through image or the user's hands, or a virtual rendering of the user's hands, may be displayed together with the virtual keyboard 230, so that the user can view a rendering of the movement of the hands relative to the virtual keyboard 230 corresponding to actual movement of the user's hands, providing some visual verification to the user of inputs made via the virtual keyboard 230. In some implementations, a visual appearance of the virtual keys of the virtual keyboard 230 may be altered as virtual depression of the virtual keys is detected, including, for example, a virtual rendering of the virtual keys in the depressed state, virtual highlighting of the virtual keys as they are depressed, or other changes in appearance.

In the example shown in FIG. 2, the virtual keyboard 230 is provided as an example user input interface. However, various other virtual user input interfaces may also be generated and displayed to the user for manipulation, input and interaction in the augmented reality/virtual reality environment in a similar manner. For example, a virtual list 240 including a plurality of virtual menu items may also be rendered and displayed for user manipulation and interaction such as, for example, scrolling through the virtual list 240, selecting a virtual menu item 240A from the virtual list 240, and the like. Such a virtual list 240 may be displayed at the flat region 210 corresponding to the physical work surface, as shown in FIG. 2, so that the user may experience physical contact with the physical work surface when manipulating and interacting with the virtual list 240. Other items, such as, for example, virtual icons, virtual shortcuts, virtual links and the like may also be displayed for manipulation by the user in a similar manner.

In some implementations, these virtual user input interfaces (virtual keyboard, virtual lists, virtual icons, virtual links and the like) may be displayed in locations other than the flat region 210. For example, in some implementations, a virtual user input interface may be displayed adjacent to a virtual display screen displaying associated information, essentially suspended in a manner similar to the virtual display screens.

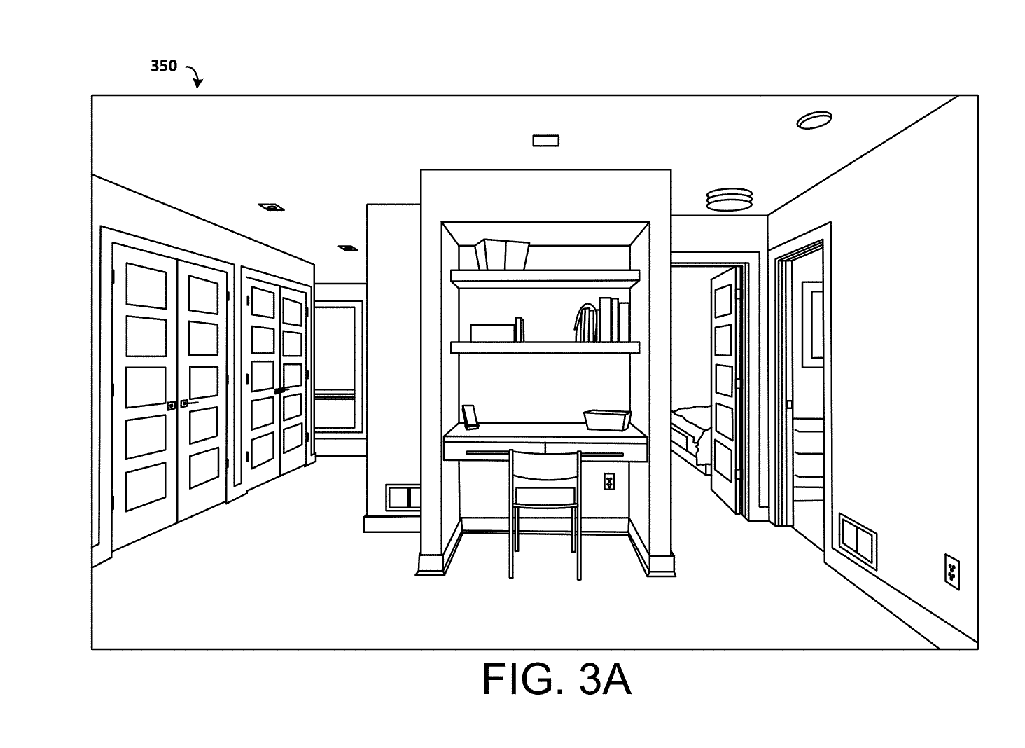

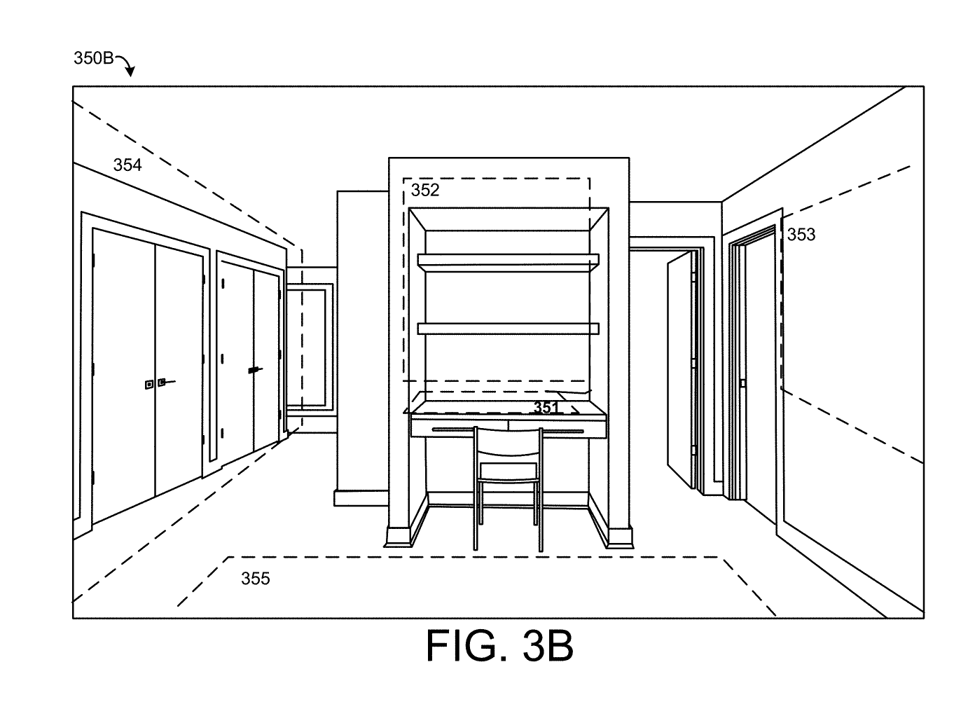

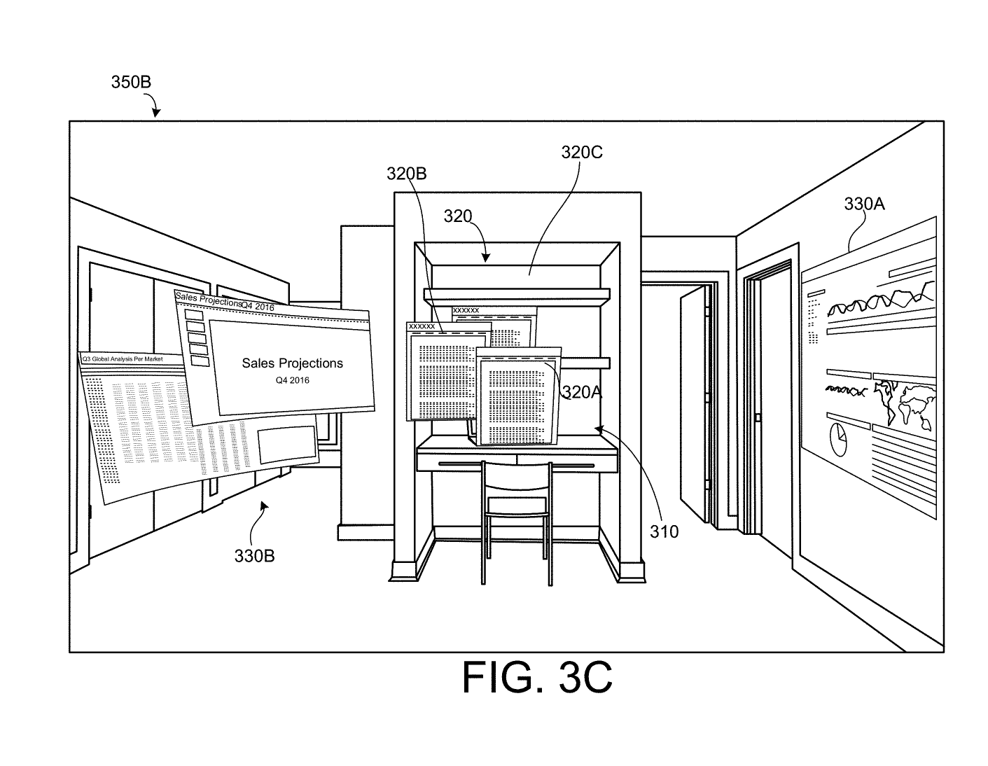

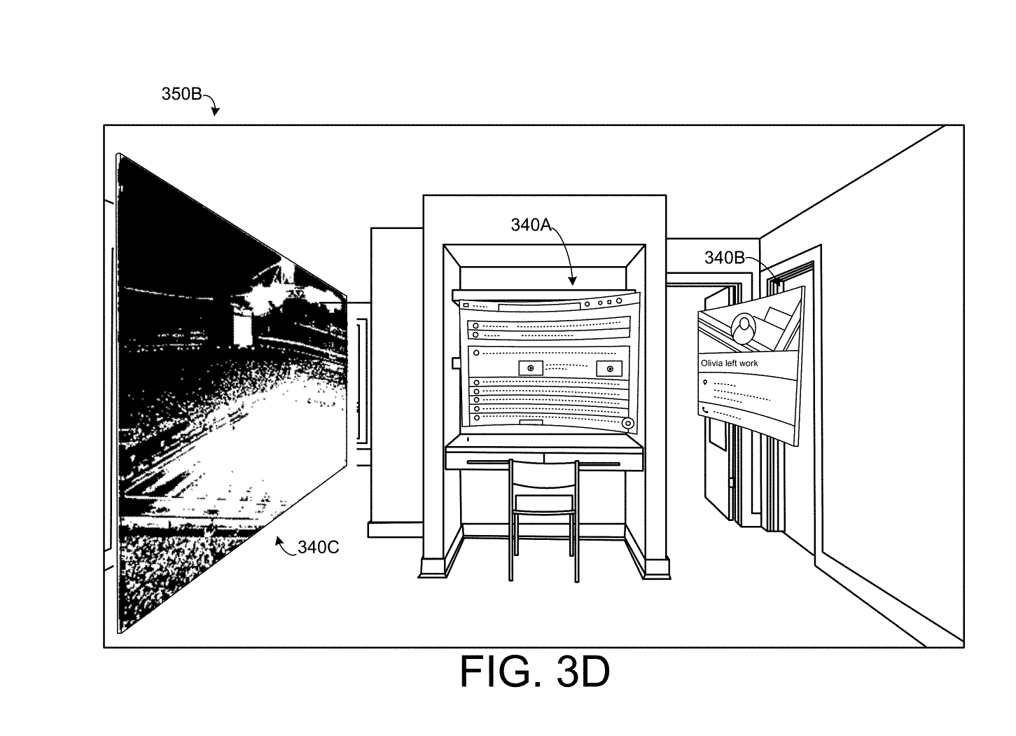

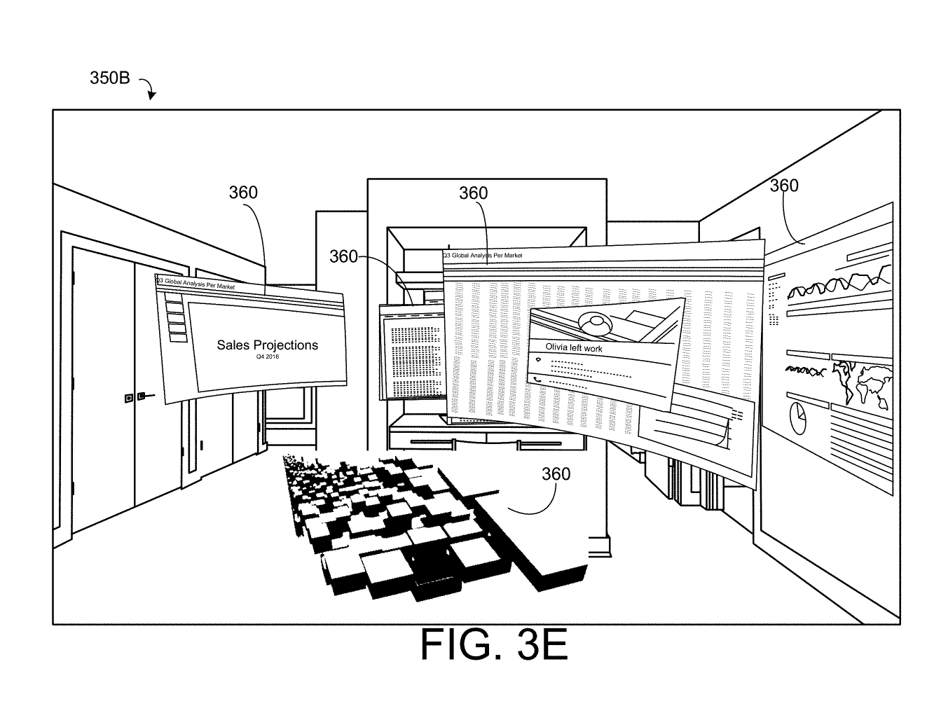

FIG. 3A illustrates a third person view of an ambient environment 350 to be captured by an augmented reality/virtual reality system for rendering a 3D virtual model 350B of the ambient environment 350, as described above with respect to FIGS. 1A and 1B. In capturing images and information related to the ambient environment 350 to be used in rendering a 3D virtual model 350B of the ambient environment 350, as shown in FIG. 3B, a plurality of drop targets 351, 352, 353, 354 and 355 may be identified, each being defined by a set of characteristics such as, for example, size, shape, area, aspect ratio, orientation, contour, texture and the like, as described above in more detail with respect to FIG. 1B. The drop targets 351-355 shown in FIG. 3B are merely examples of drop targets (and areas associated with the drop targets) that may be identified in rendering the 3D virtual model 350B of the ambient environment 350. A plurality of different drop targets may be identified for the same ambient environment depending on, for example, set user preferences, historical usage, intended usage, factory settings, and the like. Similarly, in some implementations, drop targets (and areas associated with drop targets) may be re-assessed and/or re-identified as usage requirements change.

As described above with respect to FIG. 2, one or more of the identified drop targets 351-355 may be associated with a horizontally oriented flat region sized and positioned to accommodate a virtual workstation. For example, as shown in FIG. 3B, the first drop target 351 may identify a horizontally oriented flat region sized and positioned to accommodate a virtual workstation 310. It may be determined that a length of the flat region associated with the first drop target 351 may not be sufficient to accommodate a horizontal arrangement of multiple virtual display screens as shown in FIG. 2. However, it may be determined that the adjacent, vertically oriented second drop target 352 may accommodate a vertical layering, or tiling, of virtual display screens 320 (320A, 320B, 320C), as shown in FIG. 3C. This automatic, intelligent sizing and placement of the multiple virtual display screens 320 at the first and second drop targets 351 and 352 in the 3D virtual model 350B of the ambient environment 350 may facilitate the user's interaction in the augmented reality/virtual reality environment, without the need for manual selection of placement, manual sizing and adjustment of screens and the like.

The user may choose to display other virtual display screens, or application windows, perhaps in an enlarged state depending on the size and available area associated with the drop targets. For example, as shown in FIG. 3C, the user may choose to launch a first presentation window 330A displaying a first type of visual information. As described above, the system may select the third drop target 353 for virtual display of the first presentation window 330A based on, for example, the area and/or aspect ratio associated with the third drop target 353, the texture associated with the third drop target 353, and other such characteristics. The system may automatically select the area associated with the third drop target 353 for display of the first presentation window 330A, and automatically size the first presentation window 330A without manual user intervention based on, for example, the size and/or area and/or aspect ratio associated with the third drop target 353 and the content to be displayed in the first presentation window 330A.

Similarly, the user may choose to launch a second presentation window 330B displaying a second type of visual information. As described above, the system may select the fourth drop target 354 for virtual display of the second presentation window 330B based on, for example, the area and/or aspect ratio associated with the fourth drop target 354, the texture associated with fourth drop target 354, and other such characteristics. In the example shown in FIG. 3C, the second presentation window 330B includes a virtual display of multiple tiled screens accommodated within the virtual area associated with the fourth drop target 354. The system may automatically select the area associated with the fourth drop target 354 for display of the second presentation window 330B, and automatically size and arrange the multiple virtual display screens of the second presentation window 330B based on, for example, the size and/or area and/or aspect ratio associated with the fourth drop target 354 and the content to be displayed in the second presentation window 330B.

In the example shown in FIG. 3C, locations for a virtual workstation 310 with multiple tiled virtual display screens 320 at the work surface, and multiple presentation windows 330A and 330B provided in adjacent viewing areas are automatically selected, and the virtual elements are automatically sized based on the content to be displayed and the area available for display, thus facilitating user interaction in the augmented reality/virtual reality environment, and enhancing the user's experience in the environment.

In the example shown in FIG. 3C, the first and second presentation windows 330A and 330B may be virtually positioned at opposite outer sides of the virtual display screens 320 at the virtual workstation 310, and the first and second presentation windows 330A and 330B may be considered an extension of the virtual workstation 310, outside of the area of the flat region associated with the first drop target 351. Thus, the arrangement may be similar in arrangement, but different in scale, than the example shown in FIG. 3B.

FIG. 3D illustrates an example in which a first application window 340A (for example, an email application) is displayed in the area of the second drop target 352. In this example, the first application window 340A has been not only intelligently placed and sized by the system, but has also been intelligently shaped and oriented accommodate a substantially full display of the information to be presented in the first application window 340A within the area associated with the second drop target 352. The area associated with the second drop target 352 may be selected for display of the first application window 340A, and adjacent to the flat region associated with the first drop target 351, as the information to be displayed in the first application window 340A may be manipulated and/or capable of receiving input from a virtual keyboard displayed in an area corresponding to the first drop target 351, as previously described. The user may choose to launch a second application window 340B (for example, a mapping application) and a third application window 340C (for example, a video streaming application). As described above, the system may automatically place and size the second and third application windows 340B and 340C based on, for example, size, available area, texture, content to be displayed, and the like. In the arrangement shown in FIG. 3D, the user may work at the virtual workstation, interacting with the first application window 340A via, for example, manipulation of a virtual keyboard displayed in the area associated with the first drop target 351, while intermittently monitoring mapping information displayed in the second application window 340B, and/or intermittently watching the video stream in the third application window 340C. This intelligent placement and sizing of the first, second and third application windows 340A, 340B and 340C may make optimal use of the available space and arrangement of features in the ambient environment.

In some implementations, an ambient environment, and the 3D virtual model of the ambient environment, may include some areas, for example, exclusion areas, where objects cannot, or should not be placed, or dropped. For example, a user may choose to set an area in the ambient environment corresponding to a doorway as an exclusion area, so that the user's access to the doorway is not inhibited by a virtual object placed in the area of the doorway. These types of exclusion areas may be, for example, set by the user.

FIG. 3E illustrates an example in which multiple application windows 360 may be displayed in an open area of the 3D virtual model 350B of the ambient environment 350, allowing the user to walk around the virtual visualization of the multiple application windows 360. Intelligent placement of the multiple application windows 360, and intelligent sizing of the multiple application windows 360, may facilitate user interaction with the multiple application windows 360, and enhance the user experience in the augmented reality/virtual reality environment. Multiple application windows 360 are illustrated in the example shown in FIG. 3E. However, other types of virtual objects may be intelligently sized and placed throughout the open area of the 3D virtual model 350B of the ambient environment in a similar manner, allowing the user to walk amidst the virtual visualizations of the virtual objects and interact with the virtual objects as described above.

In a system and method, in accordance with implementations described herein, virtual objects, virtual windows, virtual user interfaces and the like may be intelligently placed and intelligently sized, in a 3D virtual model of an ambient environment, without manual user intervention or manipulation, thus facilitating user interaction in the augmented reality/virtual reality environment and enhancing the user's experience in the environment.

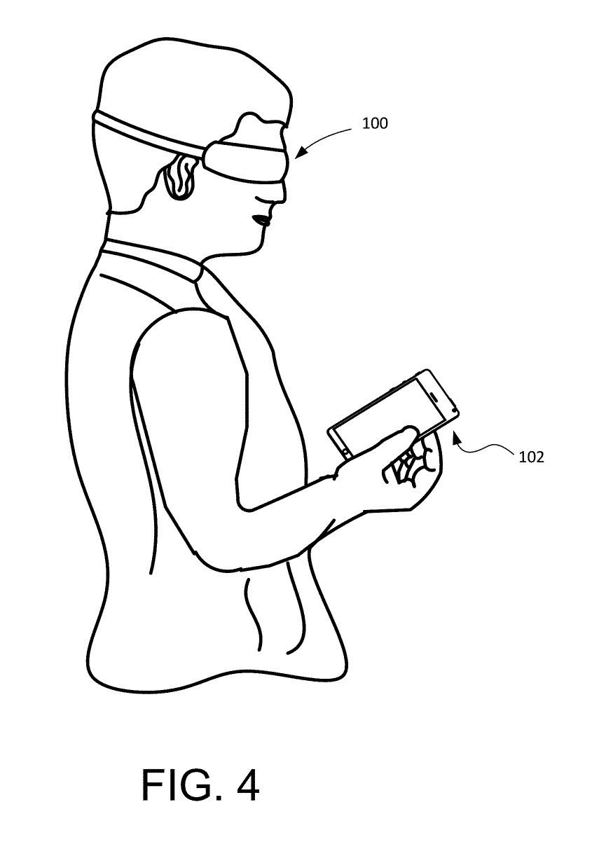

As noted above, the augmented reality environment and/or virtual reality environment may be generated by a system including, for example, an HMD 100 worn by a user, as shown in FIG. 4. As discussed above, the HMD 100 may be controlled by various different types of user inputs, and the user may interact with the augmented reality/virtual reality environment generated by the HMD 100 through various different types of user inputs, including, for example, hand/arm gestures, head gestures, manipulation of the HMD 100, manipulation of a portable controller 102 operably coupled to the HMD 100, and the like. In the example shown in FIG. 4, one portable controller 102 is illustrated. However, more than one portable controller 102 may be operably coupled with the HMD 100, and/or with other computing devices external to the HMD 100 operating with the system.

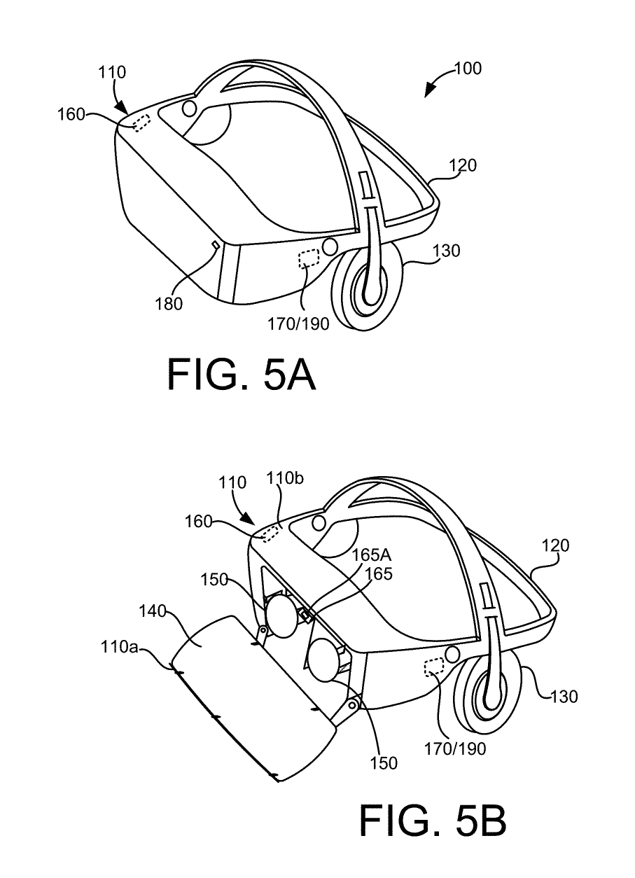

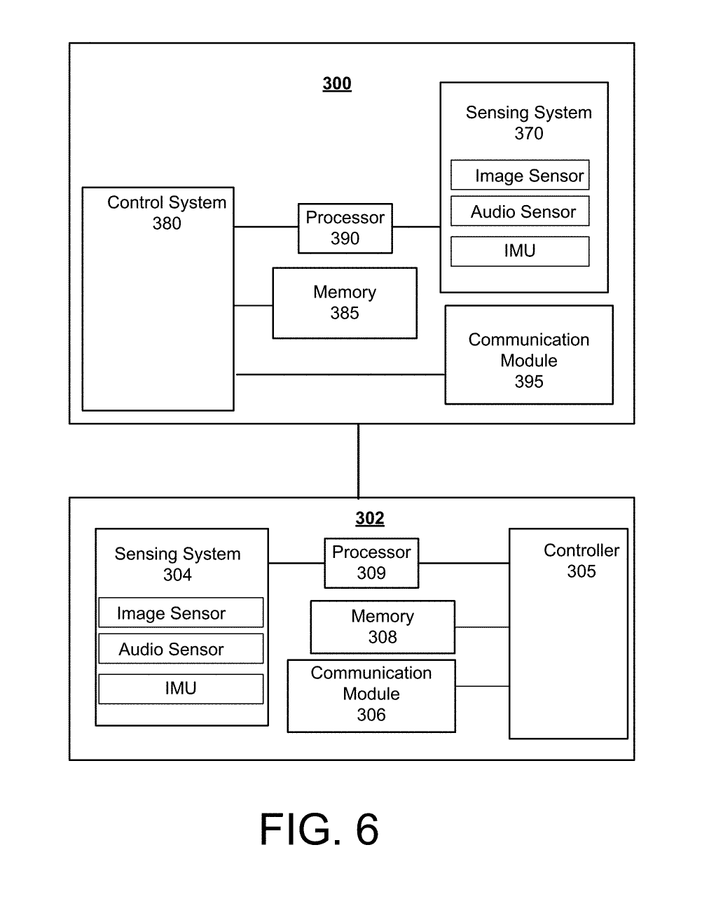

FIGS. 5A and 5B are perspective views of an example HMD, such as, for example, the HMD 100 worn by the user in FIG. 4. FIG. 6 is a block diagram of an augmented and/or virtual reality system including a first electronic device in communication with at least one second electronic device. The first electronic device 300 may be, for example an HMD 100 as shown in FIGS. 4, 5A and 5B, generating an augmented/virtual reality environment, and the second electronic device 302 may be, for example, one or more controllers 102 as shown in FIG. 4.

As shown in FIGS. 5A and 5B, the example HMD may include a housing 110 coupled to a frame 120, with an audio output device 130 including, for example, speakers mounted in headphones, coupled to the frame 120. In FIG. 2B, a front portion 110a of the housing 110 is rotated away from a base portion 110b of the housing 110 so that some of the components received in the housing 110 are visible. A display 140 may be mounted on an interior facing side of the front portion 110a of the housing 110. Lenses 150 may be mounted in the housing 110, between the user's eyes and the display 140 when the front portion 110a is in the closed position against the base portion 110b of the housing 110. In some implementations, the HMD 100 may include a sensing system 160 including various sensors such as, for example, audio sensor(s), image/light sensor(s), positional sensors (e.g., inertial measurement unit including gyroscope and accelerometer), and the like. The HMD 100 may also include a control system 170 including a processor 190 and various control system devices to facilitate operation of the HMD 100.

In some implementations, the HMD 100 may include a camera 180 to capture still and moving images. The images captured by the camera 180 may be used to help track a physical position of the user and/or the controller 102, and/or may be displayed to the user on the display 140 in a pass through mode. In some implementations, the HMD 100 may include a gaze tracking device 165 including one or more image sensors 165A to detect and track an eye gaze of the user. In some implementations, the HMD 100 may be configured so that the detected gaze is processed as a user input to be translated into a corresponding interaction in the augmented reality/virtual reality environment.

As shown in FIG. 6, the first electronic device 300 may include a sensing system 370 and a control system 380, which may be similar to the sensing system 160 and the control system 170, respectively, shown in FIGS. 5A and 5B. The sensing system 370 may include, for example, a light sensor, an audio sensor, an image sensor, a distance/proximity sensor, a positional sensor, an inertial measurement unit (IMU) including, for example, a gyroscope, an accelerometer, a magnetometer, and the like, and/or other sensors and/or different combination(s) of sensors, including, for example, an image sensor positioned to detect and track the user's eye gaze, such as the gaze tracking device 165 shown in FIG. 5B. The control system 380 may include, for example, a power/pause control device, audio and video control devices, an optical control device, a transition control device, and/or other such devices and/or different combination(s) of devices. The sensing system 370 and/or the control system 380 may include more, or fewer, devices, depending on a particular implementation, and may have a different physical arrangement that shown. The first electronic device 300 may also include a processor 390 in communication with the sensing system 370 and the control system 380, a memory 385, and a communication module 395 providing for communication between the first electronic device 300 and another, external device, such as, for example, the second electronic device 302.

The second electronic device 302 may include a communication module 306 providing for communication between the second electronic device 302 and another, external device, such as, for example, the first electronic device 300. The second electronic device 302 may include a sensing system 304 including an image sensor and an audio sensor, such as is included in, for example, a camera and microphone, an inertial measurement unit including, for example, a gyroscope, an accelerometer, a magnetometer, and the like, a touch sensor such as is included in a touch sensitive surface of a controller, or smartphone, and other such sensors and/or different combination(s) of sensors. A processor 309 may be in communication with the sensing system 304 and a control unit 305 of the second electronic device 302, the control unit 305 having access to a memory 308 and controlling overall operation of the second electronic device 302.

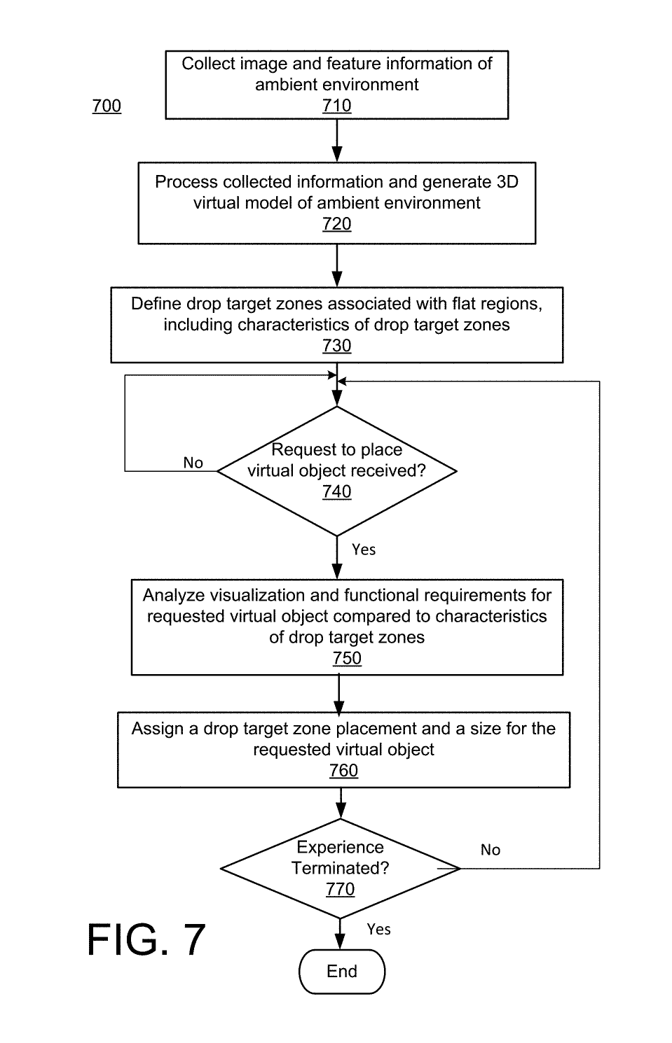

A method 700 of intelligent sizing and placement of virtual objects in an augmented and/or a virtual reality environment, in accordance with implementations described herein, is shown in FIG. 7.

A user may initiate an augmented and/or a virtual reality experience in an ambient environment, or real world space, using, for example, a computing device such as, for example, a head mounted display device, to generate the augmented reality/virtual reality environment. The computing device, for example, the HMD, may collect image and feature information from the ambient environment using, for example a camera or plurality of cameras, light sensors, depth sensors, proximity sensors and the like included in the computing device (block 710). The computing device may process the collected image and feature information to generate a three dimensional virtual model of the ambient environment (block 720). The computing device may then analyze the collected image and feature information and the three dimensional virtual model to define one or more drop target zones associated with flat regions identified in the three dimensional virtual model (block 730). Various characteristics may be associated with the drop target zones and associated flat regions, including, for example, dimensions, aspect ratio, orientation, texture, contours of other features, and the like.

In response to a user request to place a virtual object in the three dimensional virtual model (block 740), the computing device may analyze visualization requirements and functional requirements associated with the requested virtual object compared to the characteristics associated with the drop target zones (block 750). As noted above the virtual object may include, for example, an application window, an informational window, personal objects, computer display screens and the like. The computing device may then assign a placement for the requested virtual object in the three dimensional virtual model, and a size of the requested virtual object at the assigned placement (block 760). When analyzing the visualization requirements and functional requirements associated with placement and sizing of the requested virtual object, the computing device may refer to an established set of rules, algorithms and the like for placement and sizing, taking into consideration, for example, anticipated user interaction with the requested virtual object, static versus dynamic images displayed within the requested virtual object, and the like. The process may continue until it is determined that the current augmented reality/virtual reality experience has been terminated.

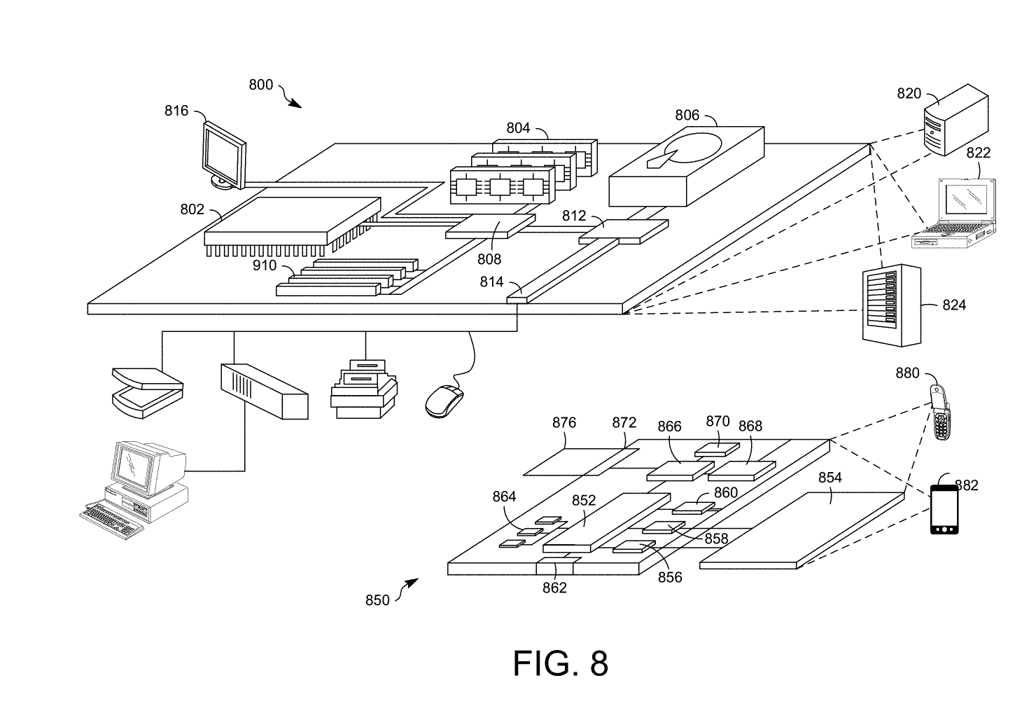

FIG. 8 shows an example of a generic computer device 800 and a generic mobile computer device 850, which may be used with the techniques described here. Computing device 800 is intended to represent various forms of digital computers, such as laptops, desktops, tablets, workstations, personal digital assistants, televisions, servers, blade servers, mainframes, and other appropriate computing devices. Computing device 850 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. The processor 802 can be a semiconductor-based processor. The memory 804 can be a semiconductor-based memory. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, or memory on processor 802.

The high speed controller 808 manages bandwidth-intensive operations for the computing device 800, while the low speed controller 812 manages lower bandwidth-intensive operations. Such allocation of functions is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provide in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provide as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852, that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, WiFi, or other such transceiver (not shown). In addition, GPS (Global Positioning System) receiver module 870 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smart phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device (computer-readable medium), for processing by, or to control the operation of, data processing apparatus, e.g., a programmable processor, a computer, or multiple computers. Thus, a computer-readable storage medium can be configured to store instructions that when executed cause a processor (e.g., a processor at a host device, a processor at a client device) to perform a process.

A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT), a light emitting diode (LED), or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method, comprising:
capturing, with one or more optical sensors of a computing device, feature information of an ambient environment;
generating, by a processor of the computing device, a three dimensional virtual model of the ambient environment based on the captured feature information;
processing, by the processor, the captured feature information and the three dimensional virtual model to define a plurality of virtual drop targets in the three dimensional virtual model, the plurality of virtual drop targets being respectively associated with a plurality of drop regions;
receiving, by the computing device, a request to place a virtual object in the three dimensional virtual model;
selecting, by the computing device, a virtual drop target, of the plurality of virtual drop targets, for placement of the virtual object in the three dimensional virtual model, based on attributes of the virtual object and characteristics of the plurality of virtual drop targets;
sizing, by the computing device, the virtual object based on the characteristics of the selected virtual drop target; and
displaying the sized virtual object at the selected drop virtual target in the displayed three dimensional virtual model.

2. The method of claim 1, capturing feature information of an ambient environment including capturing images of physical objects in the ambient environment, capturing physical boundaries of the ambient environment, and capturing depth data associated with the physical objects in the ambient environment.

3. The method of claim 1, processing the captured feature information and the three dimensional virtual model to define a plurality of virtual drop targets in the virtual model respectively associated with a plurality of drop regions including:
detecting a plurality of virtual drop regions in the three dimensional virtual model corresponding to a plurality of physical drop regions in the ambient environment; and
detecting a plurality of characteristics associated with the plurality of virtual drop regions in the virtual model.

4. The method of claim 3, detecting a plurality of characteristics associated with the plurality of virtual drop regions including:
detecting at least one of a planarity, one or more dimensions, an area, an orientation, one or more corners, one or more boundaries, a contour or a surface texture for each of the plurality of physical drop regions; and
associating the detected characteristics of each of the plurality of physical drop regions in the ambient environment with a corresponding virtual drop region of the plurality of virtual drop regions in the virtual model.

5. The method of claim 4, selecting a virtual drop target for placement of the virtual object in the three dimensional virtual model including:
detecting functional attributes and sizing attributes of the virtual object;
comparing the detected functional attributes and sizing attributes of the virtual object to the characteristics associated with each of the plurality of virtual drop regions; and
matching the virtual object to one of the plurality of virtual drop targets corresponding to one of the plurality of virtual drop regions based on the comparison.

6. The method of claim 5, sizing the virtual object based on characteristics of the selected virtual drop target and displaying the sized virtual object at the selected virtual drop target in the displayed three dimensional virtual model including:
sizing the virtual object based on the functional attributes of the virtual object and an available virtual area associated with the one of the plurality of virtual drop targets corresponding to the one of the plurality of virtual drop regions.

7. The method of claim 1, wherein the virtual object is an application window, and wherein sizing the virtual object based on characteristics of the selected virtual drop target and displaying the sized virtual object at the selected virtual drop target in the displayed three dimensional virtual model includes:
selecting a virtual drop target of the plurality of virtual drop targets corresponding to a vertical drop region of the plurality of virtual drop regions, the vertical drop region corresponding to a vertically oriented planar surface having a largest vertically oriented planar surface area of the plurality of physical drop regions in the ambient environment; and
sizing the application window for display at the selected virtual drop target based on the planar surface area of the vertical drop region.

8. The method of claim 1, wherein the virtual object is a virtual user input interface, and wherein sizing the virtual object based on characteristics of the selected virtual drop target and displaying the sized virtual object at the selected virtual drop target in the displayed three dimensional virtual model includes:
selecting a virtual drop target of the plurality of virtual drop targets corresponding to a horizontal drop region of the plurality of virtual drop regions, the horizontal drop region corresponding to a horizontally oriented planar surface having a planar surface area in the ambient environment that is positioned and sized to accommodate the virtual user input interface; and
sizing the virtual user input interface for display at the selected virtual drop target based on the planar surface area of the horizontal drop region.

9. The method of claim 1, wherein the virtual object includes at least one virtual display screen and at least one virtual user input interface, and wherein sizing the virtual object based on characteristics of the selected virtual drop target and displaying the sized virtual object at the selected virtual drop target in the displayed three dimensional virtual model includes:
selecting a first virtual drop target corresponding to a vertical drop region being defined by a vertically oriented planar surface in the ambient environment having an area corresponding to a virtual display area of the at least one virtual display screen;
selecting a second virtual drop target corresponding to a horizontal drop region being defined by a horizontally oriented planar surface in the ambient environment, the horizontal drop region corresponding to the second virtual drop target being adjacent to the vertical drop region corresponding to the first virtual drop target;
sizing the at least one virtual display screen for display at the first virtual drop target based on the planar surface area of the vertical drop region;
sizing the at least one virtual user input interface for display at the second virtual drop target based on the planar surface area of the horizontal drop region; and
displaying the sized at least one virtual display screen in the vertical drop region and displaying the sized at least one virtual user input interface in the horizontal drop region.

10. The method of claim 1, further comprising:
detecting a position of a user relative to the plurality of virtual drop targets respectively associated with the plurality of drop regions;
selecting a virtual drop target, of the plurality of drop targets, based on the detected position of the user relative to the plurality of drop targets;
selecting one or more virtual objects to be displayed to the user at the selected virtual drop target based on characteristics of the selected virtual drop target and functional attributes of the one or more virtual objects; and
displaying the selected one or more virtual objects at the selected virtual drop target.

11. A computer program product embodied on a non-transitory computer readable medium, the computer readable medium having stored thereon a sequence of instructions which, when executed by a processor, causes the processor to execute a method, the method comprising:
capturing, with one or more optical sensors of a computing device, feature information of an ambient environment;
generating, by a processor of the computing device, a three dimensional virtual model of the ambient environment based on the captured feature information;
processing, by the processor, the captured feature information and the three dimensional virtual model to define a plurality of virtual drop targets in the three dimensional virtual model, the plurality of virtual drop targets being respectively associated with a plurality of drop regions;
receiving, by the computing device, a request to place a virtual object in the three dimensional virtual model;
selecting, by the computing device, a virtual drop target, of the plurality of virtual drop targets, for placement of the virtual object in the three dimensional virtual model, based on attributes of the virtual object and characteristics of the plurality of virtual drop targets;
sizing, by the computing device, the virtual object based on the characteristics of the selected virtual drop target; and
displaying the sized virtual object at the selected drop virtual target in the displayed three dimensional virtual model.

12. The computer program product of claim 11, processing the captured feature information and the three dimensional virtual model to define a plurality of virtual drop targets in the virtual model respectively associated with a plurality of drop regions including:
detecting a plurality of virtual drop regions in the three dimensional virtual model corresponding to a plurality of physical drop regions in the ambient environment; and
detecting a plurality of characteristics associated with the plurality of virtual drop regions in the virtual model, including:
detecting at least one of a planarity, one or more dimensions, an area, an orientation, one or more corners, one or more boundaries, a contour or a surface texture for each of the plurality of physical drop regions; and
associating the detected characteristics of each of the plurality of physical drop regions in the ambient environment with a corresponding virtual drop region of the plurality of virtual drop regions in the virtual model.

13. The computer program product of claim 12, selecting a virtual drop target for placement of the virtual object in the three dimensional virtual model including:
detecting functional attributes and sizing attributes of the virtual object;
comparing the detected functional attributes and sizing attributes of the virtual object to the characteristics associated with each of the plurality of virtual drop regions; and
matching the virtual object to one of the plurality of virtual drop targets corresponding to one of the plurality of virtual drop regions based on the comparison.

14. The computer program product of claim 13, sizing the virtual object based on characteristics of the selected virtual drop target and displaying the sized virtual object at the selected virtual drop target in the displayed three dimensional virtual model including:
sizing the virtual object based on the functional attributes of the virtual object and an available virtual area associated with the one of the plurality of virtual drop targets corresponding to the one of the plurality of virtual drop regions.

15. The computer program product of claim 11, wherein the virtual object is an application window, and wherein sizing the virtual object based on characteristics of the selected virtual drop target and displaying the sized virtual object at the selected virtual drop target in the displayed three dimensional virtual model includes:
selecting a virtual drop target of the plurality of virtual drop targets corresponding to a vertical drop region of the plurality of virtual drop regions, the vertical drop region corresponding to a vertically oriented planar surface having a largest vertically oriented planar surface area of the plurality of physical drop regions in the ambient environment; and
sizing the application window for display at the selected virtual drop target based on the planar surface area of the vertical drop region.

16. The computer program product of claim 11, wherein the virtual object is a virtual user input interface, and wherein sizing the virtual object based on characteristics of the selected virtual drop target and displaying the sized virtual object at the selected virtual drop target in the displayed three dimensional virtual model includes:
selecting a virtual drop target of the plurality of virtual drop targets corresponding to a horizontal drop region of the plurality of virtual drop regions, the horizontal drop region corresponding to a horizontally oriented planar surface having a planar surface area in the ambient environment that is positioned and sized to accommodate the virtual user input interface; and
sizing the virtual user input interface for display at the selected virtual drop target based on the planar surface area of the horizontal drop region.

17. The computer program product of claim 11, wherein the virtual object includes at least one virtual display screen and at least one virtual user input interface, and wherein sizing the virtual object based on characteristics of the selected virtual drop target and displaying the sized virtual object at the selected virtual drop target in the displayed three dimensional virtual model includes:
selecting a first virtual drop target corresponding to a vertical drop region being defined by a vertically oriented planar surface in the ambient environment having an area corresponding to a virtual display area of the at least one virtual display screen;
selecting a second virtual drop target corresponding to a horizontal drop region being defined by a horizontally oriented planar surface in the ambient environment, the horizontal drop region corresponding to the second virtual drop target being adjacent to the vertical drop region corresponding to the first virtual drop target;
sizing the at least one virtual display screen for display at the first virtual drop target based on the planar surface area of the vertical drop region;
sizing the at least one virtual user input interface for display at the second virtual drop target based on the planar surface area of the horizontal drop region; and
displaying the sized at least one virtual display screen in the vertical drop region and displaying the sized at least one virtual user input interface in the horizontal drop region.

18. The computer program product of claim 11, further comprising:
detecting a position of a user relative to the plurality of virtual drop targets respectively associated with the plurality of drop regions;
selecting a virtual drop target, of the plurality of drop targets, based on the detected position of the user relative to the plurality of drop targets;
selecting one or more virtual objects to be displayed to the user at the selected virtual drop target based on characteristics of the selected virtual drop target and functional attributes of the one or more virtual objects; and
displaying the selected one or more virtual objects at the selected virtual drop target.

19. A computing device, comprising:
a memory storing executable instructions; and
a processor configured to execute the instructions, to cause the computing device to:
capture feature information of an ambient environment;
generate a three dimensional virtual model of the ambient environment based on the captured feature information;
process the captured feature information and the three dimensional virtual model to define a plurality of virtual drop targets associated with a plurality of drop regions identified in the three dimensional virtual model;
receive a request to include a virtual object in the three dimensional virtual model;
select a virtual drop target, of the plurality of virtual drop targets, for placement of the virtual object in the three dimensional virtual model, and automatically size the virtual object for placement at the selected virtual drop target based on characteristics of the selected virtual drop target and previously stored criteria and functional attributes associated with the virtual object; and
display the sized virtual object at the selected virtual drop target in the displayed three dimensional virtual model.

20. The device of claim 19, wherein the computing device is a head mounted display device configured to generate a virtual reality environment including the three dimensional virtual model of the ambient environment and to automatically size and place a plurality of virtual objects in the generated virtual reality environment based on previously stored criteria and functional attributes of the plurality of virtual objects and detected characteristics of the plurality of drop regions respectively associated with the plurality of drop targets.
